(19) United States
(12) Patent Application Publication
(10) Pub. No.: US 2020/0045280 A1
(43) Pub. Date: Feb. 6, 2020

(54) IMAGING APPARATUS AND ENDOSCOPE APPARATUS

(71) Applicant: OLYMPUS CORPORATION, Tokyo (JP)

(72) Inventors: Hideaki TAKAHASHI, Tokyo (JP); Hiroshi SAKAI, Sagamihara-shi (JP)

(73) Assignee: OLYMPUS CORPORATION, Tokyo (JP)

(21) Appl. No.: 16/599,289

(22) Filed: Oct. 11, 2019

Related U.S. Application Data
(63) Continuation of application No. PCT/JP2017/015715, filed on Apr. 19, 2017.

(51) Int. Cl. H04N 9/64; H04N 9/04

(52) U.S. Cl. CPC H04N 9/646; H04N 9/04551

(57) ABSTRACT

In an imaging apparatus, a processer is configured to output a first monochrome correction image and a second monochrome correction image. The first monochrome correction image is an image generated by correcting a value based on components overlapping between a first transmittance characteristic and a second transmittance characteristic for a captured image having components based on the first transmittance characteristic. The second monochrome correction image is an image generated by correcting a value based on components overlapping between the first transmittance characteristic and the second transmittance characteristic for the captured image having components based on the second transmittance characteristic. The processer is configured to perform image processing on a processing target image out of the first and second monochrome correction images such that the difference of image quality between the first and second monochrome correction images becomes small.

The present application is a continuation application based on International Patent Application No. PCT/JP2017/015715 filed on Apr. 19, 2017, the content of which is incorporated herein by reference.

### BACKGROUND OF THE INVENTION

### Field of the Invention

The present invention relates to an imaging apparatus and an endoscope apparatus.

### Description of Related Art

Imaging devices having color filters of primary colors consisting of R (red), G (green), and B (blue) have been widely used for an imaging apparatus in recent years. When a band of the color filter becomes wide, the amount of transmitted light increases and imaging sensitivity increases. For this reason, in a typical imaging device, a method of causing transmittance characteristics of R, G, and B, color filters to intentionally overlap is used.

In a phase difference AF or the like, phase difference detection using a parallax between two pupils is performed. For example, in Japanese Unexamined Patent Application, First Publication No. 2013-044806, an imaging apparatus including a pupil division optical system having a first pupil area transmitting R and G light and a second pupil area transmitting G and B light is disclosed. A phase difference is detected on the basis of a positional deviation between an R image and a B image acquired by a color imaging device mounted on this imaging apparatus.

### SUMMARY OF THE INVENTION

According to a first aspect of the present invention, an imaging apparatus includes a pupil division optical system, an imaging device, and a processor. The pupil division optical system includes a first pupil transmitting light of a first wavelength band and a second pupil transmitting light of a second wavelength band different from the first wavelength band. The imaging device is configured to capture an image of light transmitted through the pupil division optical system and a first color filter having a first transmittance characteristic and light transmitted through the pupil division optical system and a second color filter having a second transmittance characteristic partially overlapping the first transmittance characteristic, and output the captured image. The processor is configured to generate a first monochrome correction image and a second monochrome correction image. The first monochrome correction image is an image generated by correcting a value that is based on components overlapping between the first transmittance characteristic and the second transmittance characteristic for the captured image having components that are based on the first transmittance characteristic. The second monochrome correction image is an image generated by correcting a value that is based on components overlapping between the first transmittance characteristic and the second transmittance characteristic for the captured image having components that are based on the second transmittance characteristic. The processor is configured to determine at least one of the first monochrome correction image and the second monochrome correction image as a processing target image. The processor is configured to perform image processing on the processing target image such that the difference of image quality between the first monochrome correction image and the second monochrome correction image becomes small. The first monochrome correction image and the second monochrome correction image are output to a display unit. At least one of the first monochrome correction image and the second monochrome correction image output to the display unit is an image on which the image processing has been performed by the processor.

According to a second aspect of the present invention, in the first aspect, the processor may be configured to determine at least one of the first monochrome correction image and the second monochrome correction image as the processing target image on the basis of a result of comparing the first monochrome correction image with the second monochrome correction image.

According to a third aspect of the present invention, in the first aspect, the processor may be configured to perform luminance adjustment processing on the processing target image such that the difference of luminance between the first monochrome correction image and the second monochrome correction image becomes small.

According to a fourth aspect of the present invention, in the second aspect, the processor may be configured to determine an image that has poorer image quality out of the first monochrome correction image and the second monochrome correction image as the processing target image. The processor may be configured to perform the image processing on the processing target image out of the first monochrome correction image and the second monochrome correction image and output the image different from the processing target image out of the first monochrome correction image and the second monochrome correction image to the display unit.

According to a fifth aspect of the present invention, in the second aspect, the processor may be configured to calculate a phase difference of a reference image for a standard image. The standard image is one of the first monochrome correction image and the second monochrome correction image. The reference image is the other of the first monochrome correction image and the second monochrome correction image. The processor may be configured to perform the image processing on the reference image and output the standard image to the display unit.

According to a sixth aspect of the present invention, in the fifth aspect, the processer may be configured to perform a first operation and a second operation in a time-division manner. The processer may be configured to determine the first monochrome correction image as the processing target image and perform the image processing on the determined processing target image in the first operation. The processer may be configured to determine the second monochrome correction image as the processing target image and perform the image processing on the determined processing target image in the second operation.

According to a seventh aspect of the present invention, an imaging apparatus includes a pupil division optical system, an imaging device, a correction unit, a determination unit, and an image processing unit. The pupil division optical system includes a first pupil transmitting light of a first wavelength band and a second pupil transmitting light of a second wavelength band different from the first wavelength band. The imaging device is configured to capture an image of light transmitted through the pupil division optical system and a first color filter having a first transmittance characteristic and light transmitted through the pupil division optical system and a second color filter having a second transmittance characteristic partially overlapping the first transmittance characteristic, and output the captured image. The correction unit is configured to output a first monochrome correction image and a second monochrome correction image. The first monochrome correction image is an image generated by correcting a value that is based on components overlapping between the first transmittance characteristic and the second transmittance characteristic for the captured image having components that are based on the first transmittance characteristic. The second monochrome correction image is an image generated by correcting a value that is based on components overlapping between the first transmittance characteristic and the second transmittance characteristic for the captured image having components that are based on the second transmittance characteristic. The determination unit is configured to determine at least one of the first monochrome correction image and the second monochrome correction image as a processing target image. The image processing unit is configured to perform image processing on the processing target image determined by the determination unit such that the difference of image quality between the first monochrome correction image and the second monochrome correction image becomes small. The first monochrome correction image and the second monochrome correction image are output to a display unit. At least one of the first monochrome correction image and the second monochrome correction image output to the display unit is an image on which the image processing has been performed by the image processing unit.

According to an eighth aspect of the present invention, an endoscope apparatus includes the imaging apparatus according to the first aspect.

### BRIEF DESCRIPTION OF THE DRAWINGS

FIG. 1 is a block diagram showing a configuration of an imaging apparatus according to a first embodiment of the present invention.

FIG. 2 is a block diagram showing a configuration of a pupil division optical system according to the first embodiment of the present invention.

FIG. 3 is a block diagram showing a configuration of a band limiting filter according to the first embodiment of the present invention.

FIG. 4 is a diagram showing a pixel arrangement of a Bayer image in the first embodiment of the present invention.

FIG. 5 is a diagram showing a pixel arrangement of an R image in the first embodiment of the present invention.

FIG. 6 is a diagram showing a pixel arrangement of a G image in the first embodiment of the present invention.

FIG. 7 is a diagram showing a pixel arrangement of a B image in the first embodiment of the present invention.

FIG. 8 is a diagram showing an example of spectral characteristics of an RG filter of a first pupil, a BG filter of a second pupil, and color filters of an imaging device in the first embodiment of the present invention.

FIG. 9 is a diagram showing an example of spectral characteristics of an RG filter of a first pupil, a BG filter of a second pupil, and color filters of an imaging device in the first embodiment of the present invention.

FIG. 10 is a block diagram showing a configuration of an image processing unit according to the first embodiment of the present invention.

FIG. 11 is a diagram showing an example of an image displayed in the first embodiment of the present invention.

FIG. 12 is a block diagram showing a configuration of an imaging apparatus according to a second embodiment of the present invention.

FIG. 13 is a block diagram showing a configuration of an imaging apparatus according to a fourth embodiment of the present invention.

FIG. 14 is a block diagram showing a configuration of an imaging apparatus according to a fifth embodiment of the present invention.

FIG. 15 is a diagram showing a captured image of a subject in white and black.

FIG. 16 is a diagram showing a line profile of a captured image of a subject in white and black.

FIG. 17 is a diagram showing a line profile of a captured image of a subject in white and black.

### DETAILED DESCRIPTION OF THE INVENTION

When an imaging apparatus disclosed in Japanese Unexamined Patent Application, First Publication No. 2013-044806 captures an image of a subject at a position away from the focusing position, color shift in an image occurs. The imaging apparatus including a pupil division optical system disclosed in Japanese Unexamined Patent Application, First Publication No. 2013-044806 approximates a shape and a centroid position of blur in an R image and a B image to a shape and a centroid position of blur in a G image so as to display an image in which double images due to color shift are suppressed.

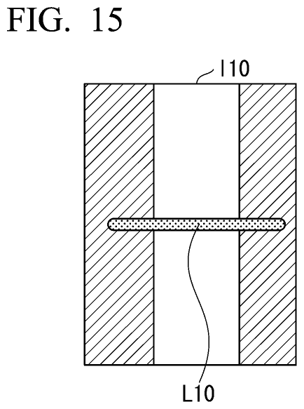

In the imaging apparatus disclosed in Japanese Unexamined Patent Application, First Publication No. 2013-044806, correction of an R image and a B image is performed on the basis of a shape of blur in a G image. For this reason, the premise is that a waveform of a G image has no distortion (no double images). However, there are cases in which a waveform of a G image has distortion. Hereinafter, distortion of a waveform of a G image will be described with reference to FIGS. 15 to 17.

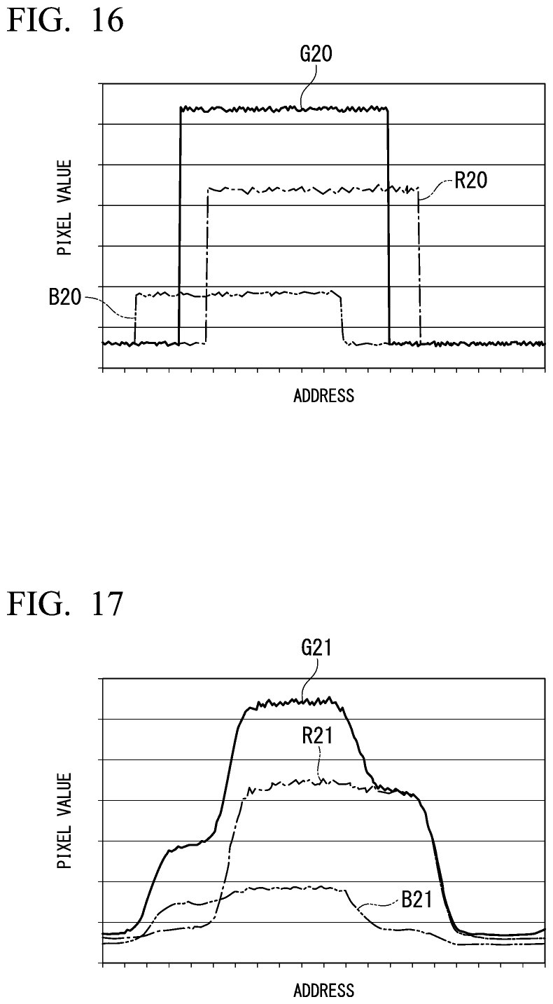

FIG. 15 shows a captured image I10 of a subject in black and white. FIGS. 16 and 17 show a profile of a line L10 in the captured image I10. The horizontal axis in FIGS. 16 and 17 represents an address of the captured image in the horizontal direction and the vertical axis represents a pixel value of the captured image. FIG. 16 shows a profile in a case where transmittance characteristics of color filters of respective colors do not overlap. FIG. 17 shows a profile in a case where transmittance characteristics of color filters of respective colors overlap. A profile R20 and a profile R21 are a profile of an R image. The R image includes information of pixels in which R color filters are disposed. A profile G20 and a profile G21 are a profile of a G image. The G image includes information of pixels in which G color filters are disposed. A profile B20 and a profile B21 are a profile of a B image. The B image includes information of pixels in which B color filters are disposed.

FIG. 16 shows that a waveform of the profile G20 of the G image has no distortion, but FIG. 17 shows that a waveform of the profile G21 of the G image has distortion. Since light transmitted through a G color filter includes components of R and B, distortion occurs in the waveform of the profile G21 of the G image. In the imaging apparatus disclosed in Japanese Unexamined Patent Application, First Publication No. 2013-044806, the profile G20 shown in FIG. 16 is the premise and the distortion of the waveform that occurs in the profile G21 shown in FIG. 17 is not the premise. For this reason, in a case where a shape and a centroid position of blur in the R image and the B image are corrected on the bases of the G image represented by the profile G21 shown in FIG. 17, the imaging apparatus displays an image including double images due to color shift.

By using an industrial endoscope apparatus, it is possible to perform measurement on the basis of a measurement point designated by a user and perform inspection of damage and the like on the basis of the measurement result. In stereo measurement using an industrial endoscope apparatus, in general, two images corresponding to left and right viewpoints are simultaneously displayed. For example, pointing of a measurement point is performed for the left image by a user and a correspondence point of stereo matching is displayed on the right image. In an industrial endoscope apparatus using a typical stereo optical system, since left and right images are generated by two similar optical systems having parallax, the difference of image quality between the left and right images is small. However, in a method in which a phase difference is acquired on the basis of an R image and a B image, the difference of image quality between the left and right images is likely to occur due to spectral sensitive characteristics of an imaging device and spectral characteristics of a subject or illumination. For example, the difference of brightness between the left and right images occurs. For this reason, there are issues that visibility is poor.

Hereinafter, embodiments of the present invention will be described with reference to the drawings.

### First Embodiment

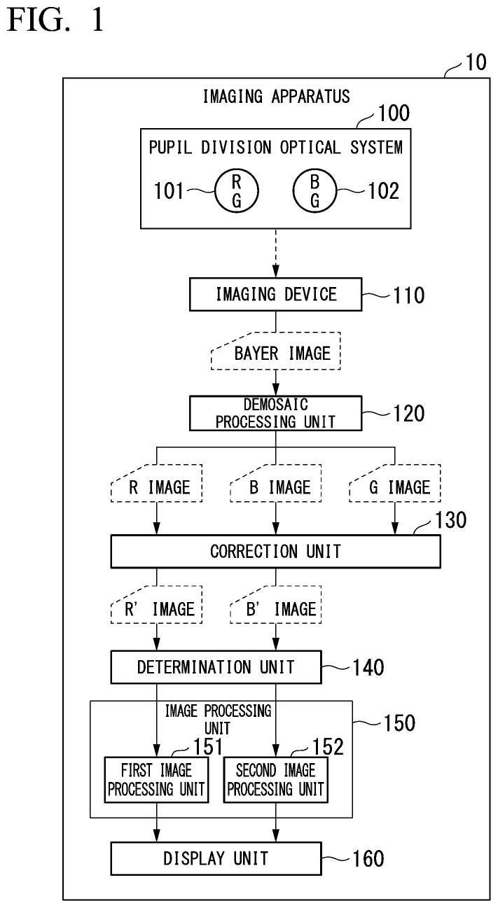

FIG. 1 shows a configuration of an imaging apparatus 10 according to a first embodiment of the present invention. The imaging apparatus 10 is a digital still camera, a video camera, a mobile phone with a camera, a mobile information terminal with a camera, a personal computer with a camera, a surveillance camera, an endoscope, a digital microscope, or the like. As shown in FIG. 1, the imaging apparatus 10 includes a pupil division optical system 100, an imaging device 110, a demosaic processing unit 120, a correction unit 130, a determination unit 140, an image processing unit 150, and a display unit 160.

A schematic configuration of the imaging apparatus 10 will be described. The pupil division optical system 100 includes a first pupil 101 transmitting light of a first wavelength band and a second pupil 102 transmitting light of a second wavelength band different from the first wavelength band. The imaging device 110 captures an image of light transmitted through the pupil division optical system 100 and a first color filter having a first transmittance characteristic, captures an image of light transmitted through the pupil division optical system 100 and a second color filter having a second transmittance characteristic partially overlapping the first transmittance characteristic, and outputs a captured image. The correction unit 130 outputs a first monochrome correction image and a second monochrome correction image. The first monochrome correction image is an image generated by correcting a value that is based on components overlapping between the first transmittance characteristic and the second transmittance characteristic for the captured image having components that is based on the first transmittance characteristic. The second monochrome correction image is an image generated by correcting a value that is based on components overlapping between the first transmittance characteristic and the second transmittance characteristic for the captured image having components that are based on the second transmittance characteristic.

The determination unit 140 determines at least one of the first monochrome correction image and the second monochrome correction image as a processing target image. The image processing unit 150 performs image processing on the processing target image determined by the determination unit 140 such that the difference of image quality between the first monochrome correction image and the second monochrome correction image becomes small. The first monochrome correction image and the second monochrome correction image are output to the display unit 160. At least one of the first monochrome correction image and the second monochrome correction image output to the display unit 160 is an image on which the image processing has been performed by the image processing unit 150. The display unit 160 displays the first monochrome correction image and the second monochrome correction image.

A detailed configuration of the information imaging apparatus 10 will be described. The first pupil 101 of the pupil division optical system 100 includes an RG filter transmitting light of wavelengths of R (red) and G (green). The second pupil 102 of the pupil division optical system 100 includes a BG filter transmitting light of wavelengths of B (blue) and G (green).

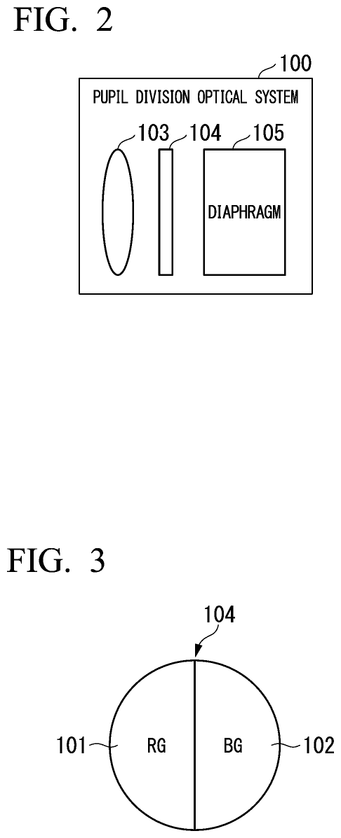

FIG. 2 shows a configuration of the pupil division optical system 100. As shown in FIG. 2, the pupil division optical system 100 includes a lens 103, a band limiting filter 104, and a diaphragm 105. For example, the lens 103 is typically constituted by a plurality of lenses in many cases. Only one lens is shown in FIG. 2 for brevity. The band limiting filter 104 is disposed on an optical path of light incident on the imaging device 110. For example, the band limiting filter 104 is disposed at the position of the diaphragm 105 or in the vicinity of the position. In the example shown in FIG. 2, the band limiting filter 104 is disposed between the lens 103 and the diaphragm 105. The diaphragm 105 adjusts brightness of light incident on the imaging device 110 by limiting the passing range of light that has passed through the lens 103.

FIG. 3 shows a configuration of the band limiting filter 104. In the example shown in FIG. 3, when the band limiting filter 104 is seen from the side of the imaging device 110, the left half of the band limiting filter 104 constitutes the first pupil 101 and the right half of the band limiting filter 104 constitutes the second pupil 102. The first pupil 101 transmits light of wavelengths of R and G, and blocks light of wavelengths of B. The second pupil 102 transmits light of wavelengths of B and G, and blocks light of wavelengths of R.

The imaging device 110 is a photoelectric conversion element such as a charge coupled device (CCD) sensor and a complementary metal oxide semiconductor (CMOS) sensor of the XY-address-scanning type. As a configuration of the imaging device 110, there is a type such as a single-plate-primary-color Bayer array and a three-plate type using three sensors. Hereinafter, an embodiment of the present invention will be described with reference to examples in which a CMOS sensor (500×500 pixels and depth of 10 bits) of the single-plate-primary-color Bayer array is used.

The imaging device 110 includes a plurality of pixels. In addition, the imaging device 110 includes color filters including a first color filter, a second color filter, and a third color filter. The color filters are disposed in each pixel of the imaging device 110. For example, the first color filter is an R filter, the second color filter is a B filter, and the third color filter is a G filter. Light transmitted through the pupil division optical system 100 and the color filters is incident on each pixel of the imaging device 110. Light transmitted through the pupil division optical system 100 contains light transmitted through the first pupil 101 and light transmitted through the second pupil 102. The imaging device 110 acquires and outputs a captured image including a pixel value of a first pixel on which light transmitted through the first color filter is incident, a pixel value of a second pixel on which light transmitted through the second color filter is incident, and a pixel value of a third pixel on which light transmitted through the third color filter is incident.

Analog front end (AFE) processing such as correlated double sampling (CDS), analog gain control (AGC), and analog-to-digital converter (ADC) is performed by the imaging device 110 on an analog captured image signal generated through photoelectric conversion in the CMOS sensor. A circuit outside the imaging device 110 may perform AFE processing. A captured image (Bayer image) acquired by the imaging device 110 is transferred to the demosaic processing unit 120.

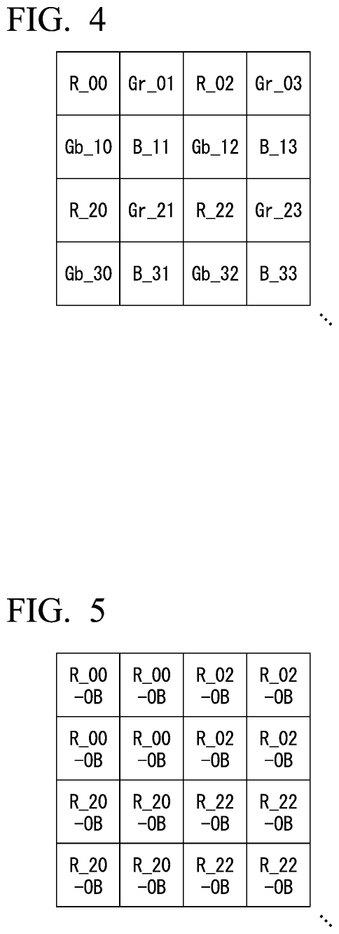

In the demosaic processing unit 120, a Bayer image is converted to an RGB image and a color image is generated. FIG. 4 shows a pixel arrangement of a Bayer image. R (red) and Gr (green) pixels are alternately disposed in odd rows and Gb (green) and B (blue) pixels are alternately disposed in even rows. R (red) and Gb (green) pixels are alternately disposed in odd columns and Gr (green) and B (blue) pixels are alternately disposed in even rows.

The demosaic processing unit 120 performs black-level correction (optical-black (OB) subtraction) on pixel values of a Bayer image. In addition, the demosaic processing unit 120 generates pixel values of adjacent pixels by copying pixel values of pixels. In this way, an RGB image having pixel values of each color in all the pixels is generated. For example, after the demosaic processing unit 120 performs OB subtraction on an R pixel value (R_00), the demosaic processing unit 120 copies a pixel value (R_00−OB). In this way, R pixel values in Gr, Gb, and B pixels adjacent to an R pixel are interpolated. FIG. 5 shows a pixel arrangement of an R image.

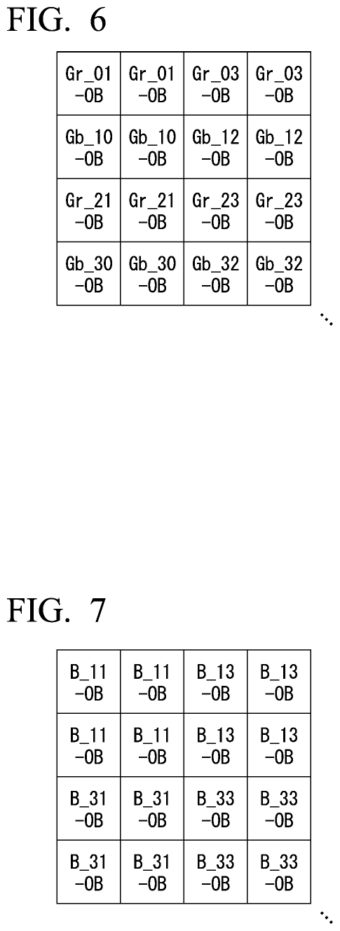

Similarly, after the demosaic processing unit 120 performs OB subtraction on a Gr pixel value (Gr_01), the demosaic processing unit 120 copies a pixel value (Gr_01−OB). In addition, after the demosaic processing unit 120 performs OB subtraction on a Gb pixel value (Gb_10), the demosaic processing unit 120 copies a pixel value (Gb_10−OB). In this way, G pixel values in an R pixel adjacent to a Gr pixel and in a B pixel adjacent to a Gb pixel are interpolated. FIG. 6 shows a pixel arrangement of a G image.

Similarly, after the demosaic processing unit 120 performs OB subtraction on a B pixel value (B_11), the demosaic processing unit 120 copies a pixel value (B_11−OB). In this way, B pixel values in R, Gr, and Gb pixels adjacent to a B pixel are interpolated. FIG. 7 shows a pixel arrangement of a B image.

The demosaic processing unit 120 generates a color image (RGB image) including an R image, a G image, and a B image through the above-described processing. A specific method of demosaic processing is not limited to the above-described method. Filtering processing may be performed on a generated RGB image. An RGB image generated by the demosaic processing unit 120 is transferred to the correction unit 130.

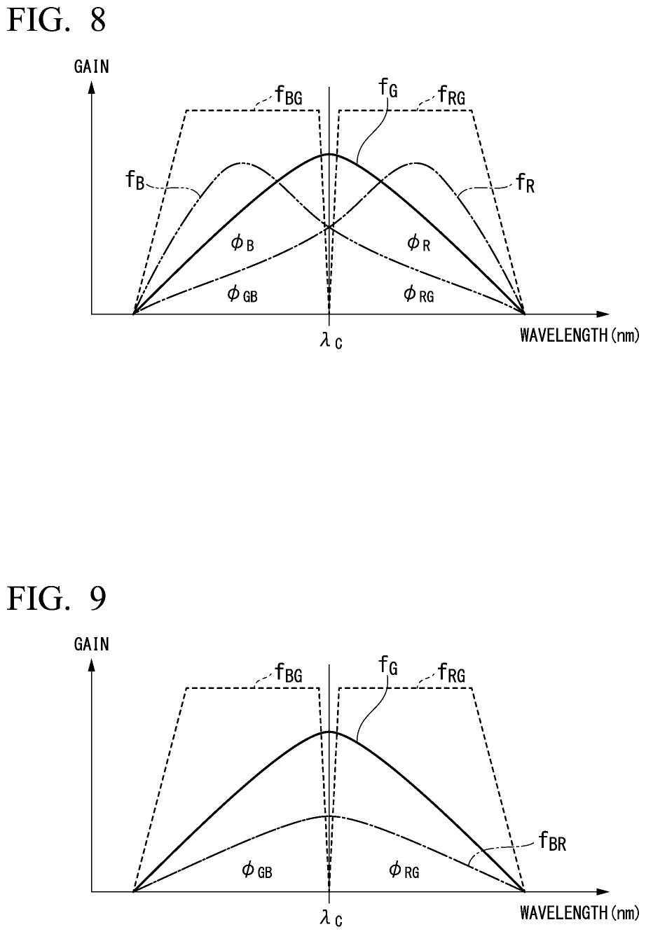

Details of processing performed by the correction unit 130 will be described. FIG. 8 shows an example of spectral characteristics (transmittance characteristics) of an RG filter of the first pupil 101, a BG filter of the second pupil 102, and color filters of the imaging device 110. The horizontal axis in FIG. 8 represents a wavelength λ [nm] and the vertical axis represents gain. A line f_{RG} represents spectral characteristics of the RG filter. A line f_{BG} represents spectral characteristics of the BG filter. A wavelength λ_{C} is the boundary between the spectral characteristics of the RG filter and the spectral characteristics of the BG filter. The RG filter transmits light of a wavelength band of longer wavelengths than the wavelength λ_{C}. The BG filter transmits light of a wavelength band of shorter wavelengths than the wavelength λ_{C}. A line f_{R} represents spectral characteristics (first spectral characteristics) of an R filter of the imaging device 110. A line f_{G} represents spectral characteristics of a G filter of the imaging device 110. Since the filtering characteristics of a Gr filter and a Gb filter are almost the same, the Gr filter and the Gb filter are shown as a G filter. A line f_{B} represents spectral characteristics (second spectral characteristics) of a B filter of the imaging device 110. Spectral characteristics of the filters of the imaging device 110 overlap.

An area between the line f_{R} and the line f_{B} in an area of longer wavelengths than the wavelength λ_{C} in the spectral characteristics shown by the line f_{R} is defined as an area φ_{R}. An area of longer wavelengths than the wavelength λ_{C} in the spectral characteristics shown by the line f_{B} is defined as an area φ_{RG}. An area between the line f_{B} and the line f_{R} in an area of shorter wavelengths than the wavelength λ_{C} in the spectral characteristics shown by the line f_{B} is defined as an area φ_{B}. An area of shorter wavelengths than the wavelength λ_{C} in the spectral characteristics shown by the line f_{R} is defined as an area φ_{GB}.

In a method in which a phase difference is acquired on the basis of an R image and a B image, for example, the difference between a phase of R (red) information and a phase of B (blue) information is acquired. R information is acquired through photoelectric conversion in R pixels of the imaging device 110 in which R filters are disposed. The R information includes information of the area φ_{B}, the area φ_{RG}, and the area φ_{GB} in FIG. 8. Information of the area φ_{R} and the area φ_{RG} is based on light transmitted through the RG filter of the first pupil 101. Information of the area φ_{GB} is based on light transmitted through the BG filter of the second pupil 102. Information of the area φ_{GB} in the R information is based on components overlapping between the spectral characteristics of the R filter and the spectral characteristics of the B filter. Since the area φ_{GB} is an area of the shorter wavelengths than the wavelength λ_{C}, the information of the area φ_{GB} is B information that causes double images due to color shift. Since this information causes distortion of a waveform of the R image and occurrence of double images, this information is undesirable for the R information.

On the other hand, B information is acquired through photoelectric conversion in B pixels of the imaging device 110 in which B filters are disposed. The B information includes information of the area φ_{B}, the area φ_{RG}, and the area φ_{GB} in FIG. 8. Information of the area φ_{B} and the area φ_{GB} is based on light transmitted through the BG filter of the second pupil 102. Information of the area φ_{RG} in the B information is based on components overlapping between the spectral characteristics of the B filter and the spectral characteristics of the R filter. Information of the area φ_{RG} is based on light transmitted through the RG filter of the first pupil 101. Since the area φ_{RG} is an area of the longer wavelengths than the wavelength λ_{C}, the information of the area φ_{RG} is R information that causes double images due to color shift. Since this information causes distortion of a waveform of the B image and occurrence of double images, this information is undesirable for the B information.

Correction is performed through which the information of the area φ_{GB} including blue information is reduced in red information and the information of the area φ_{RG} including red information is reduced in blue information. The correction unit 130 performs correction processing on the R image and the B image. In other words, the correction unit 130 reduces the information of the area φ_{GB} in red information and reduces the information of the area φ_{RG} in blue information.

FIG. 9 is a diagram similar to FIG. 8. In FIG. 9, a line f_{BR} represents the area φ_{GB} and the area φ_{RG} in FIG. 8. Spectral characteristics of the G filter shown by the line f_{G} and spectral characteristics shown by the line f_{BR} are typically similar. The correction unit 130 performs correction processing by using this feature. The correction unit 130 calculates red information and blue information by using Expression (1) and Expression (2) in the correction processing.

R′=R−α×G (1)

B′=B−β×G (2)

In Expression (1), R is red information before the correction processing is performed and R′ is red information after the correction processing is performed. In Expression (2), B is blue information before the correction processing is performed and B′ is blue information after the correction processing is performed. In this example, a and β are larger than 0 and smaller than 1. α and β are set in accordance with the spectral characteristics of the imaging device 110. In a case where the imaging apparatus 10 includes a light source for illumination, α and β are set in accordance with the spectral characteristics of the imaging device 110 and spectral characteristics of the light source. For example, α and β are stored in a memory not shown.

A value that is based on components overlapping between the spectral characteristics of the R filter and the spectral characteristics of the B filter is corrected through the operation shown in Expression (1) and Expression (2). The correction unit 130 generates an image (monochrome correction image) corrected as described above. The correction unit 130 outputs a first monochrome correction image and a second monochrome correction image by outputting a generated R′ image and a generated B′ image.

In the first embodiment, the determination unit 140 determines the first monochrome correction image (R′ image) and the second monochrome correction image (B′ image) as a processing target image. In addition, the determination unit 140 determines an image processing parameter for each of the first monochrome correction image and the second monochrome correction image. For example, the determination unit 140 detects an area having the maximum luminance value in the R′ image or the B′ image, i.e., the brightest area. The determination unit 140 calculates a proportion of the luminance value of the area to a predetermined tone. For example, the predetermined tone of a 10-bit-output CMOS sensor is 1024.

The determination unit 140 determines a gain value of luminance adjustment processing performed by the image processing unit 150 on the basis of the calculated proportion. The determination unit 140 determines a gain value for each of the R′ image and the B′ image by performing the above-described processing for each of the R′ image and the B′ image. For example, the determination unit 140 determines a gain value such that a luminance level of the R′ image and a luminance level of the B′ image become the same. Specifically, the determination unit 140 determines a gain value such that the maximum luminance value of the R′ image and the maximum luminance value of the B′ image become the same. In a case where the maximum luminance values are different between the R′ image and the B′ image, gain values are different between the R′ image and the B′ image. The determination unit 140 outputs the R′ image, the B′ image, and the gain values for these images to the image processing unit 150.

As a method of detecting an area having the maximum luminance value, a known method used by a digital camera may be used. For example, a method such as division photometry, center-weighted photometry, or spot photometry can be used.

The image processing unit 150 performs luminance adjustment processing on a processing target image determined by the determination unit 140 such that the difference of luminance between the first monochrome correction image (R′ image) and the second monochrome correction image (B′ image) becomes small. In other words, the image processing unit 150 performs the luminance adjustment processing such that a luminance level of the R′ image and a luminance level of the B′ image become the same. Specifically, the image processing unit 150 performs the luminance adjustment processing such that the maximum luminance value of the R′ image and the maximum luminance value of the B′ image become the same.

The image processing unit 150 includes a first image processing unit 151 and a second image processing unit 152. The first image processing unit 151 performs image processing on the R′ image on the basis of an image processing parameter determined by the determination unit 140. In other words, the first image processing unit 151 performs the luminance adjustment processing on the R′ image on the basis of a gain value determined by the determination unit 140. The second image processing unit 152 performs image processing on the B′ image on the basis of an image processing parameter determined by the determination unit 140. In other words, the second image processing unit 152 performs the luminance adjustment processing on the B′ image on the basis of a gain value determined by the determination unit 140.

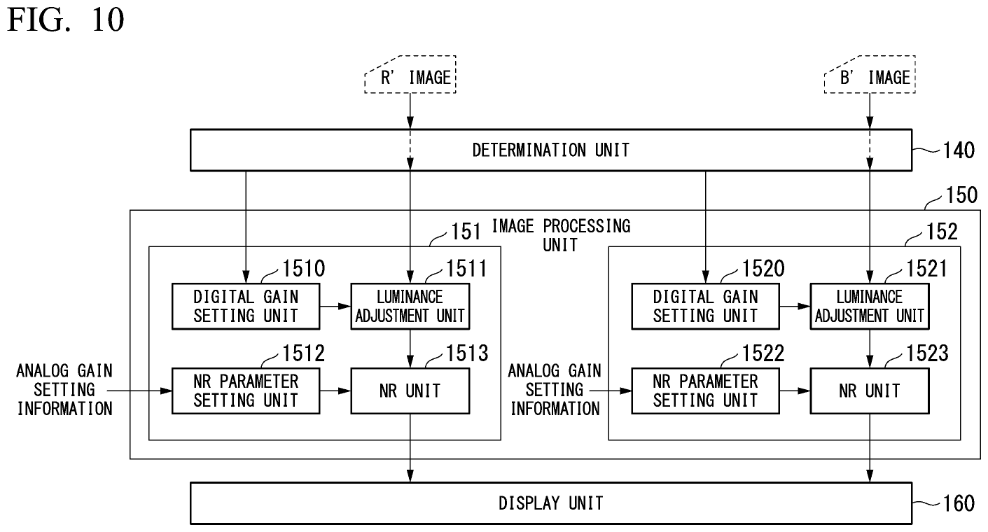

FIG. 10 shows a configuration of an image processing unit 150. The first image processing unit 151 includes a digital gain setting unit 1510, a luminance adjustment unit 1511, a noise reduction (NR) parameter setting unit 1512, and a NR unit 1513. The second image processing unit 152 includes a digital gain setting unit 1520, a luminance adjustment unit 1521, a NR parameter setting unit 1522, and a NR unit 1523.

The digital gain setting unit 1510 sets a gain value of the R′ image output from the determination unit 140 to the luminance adjustment unit 1511. A gain value (digital gain) is set such that the brightest area in an input image has predetermined brightness. For example, gain setting is performed such that 1024 tones become a full scale (0 to 1023). In this case, a gain value is set such that a luminance value of the brightest area in the input image becomes 1023. However, the upper limit value may be set to a smaller value in view of the noise of an image, the calculation error, and the like. For example, a gain value may be set such that a luminance value of the brightest area in the input image becomes 960. In addition, a nonlinear gain value may be set to a luminance value of the input image instead of a linear gain value. As long as luminance adjustment processing is performed such that the difference of luminance between the R′ image and the B′ image becomes small, a method of gain setting is not particularly limited.

The luminance adjustment unit 1511 performs the luminance adjustment processing by multiplying a pixel value (luminance value) of the R′ image by the gain value set by the digital gain setting unit 1510. The luminance adjustment unit 1511 outputs the R′ image of which luminance has been adjusted to the NR unit 1513.

The NR parameter setting unit 1512 sets a parameter that represents characteristics of a noise filter of the NR unit 1513 to the NR unit 1513. In general, noise included in an image largely depends on characteristics of an imaging device. The amount of noise varies according to the amount of analog gain given to an imaging device during photographing. The NR parameter setting unit 1512 holds a parameter of characteristics of the noise filter corresponding to the analog gain set to the imaging device 110 in advance. Analog gain setting information that represents the analog gain set to the imaging device 110 is input to the NR parameter setting unit 1512. The NR parameter setting unit 1512 determines a parameter corresponding to the analog gain setting information and sets the determined parameter to the NR unit 1513.

The NR unit 1513 performs noise elimination (noise reduction) on the R′ image. For example, a typical filter such as a moving average filter and a median filter can be used for a configuration of the NR unit 1513. The configuration of the NR unit 1513 is not limited to these. The NR unit 1513 outputs the R′ image on which the noise elimination has been performed to the display unit 160.

The digital gain setting unit 1520 is constituted similarly to the digital gain setting unit 1510. The digital gain setting unit 1520 sets a gain value of the B′ image output from the determination unit 140 to the luminance adjustment unit 1521.

The luminance adjustment unit 1521 is constituted similarly to the luminance adjustment unit 1511. The luminance adjustment unit 1521 performs the luminance adjustment processing by multiplying a pixel value (luminance value) of the B′ image by the gain value set by the digital gain setting unit 1520. The luminance adjustment unit 1521 outputs the B′ image of which luminance has been adjusted to the NR unit 1523.

The NR parameter setting unit 1522 is constituted similarly to the NR parameter setting unit 1512. The NR parameter setting unit 1522 sets a parameter that represents characteristics of a noise filter of the NR unit 1523 to the NR unit 1523.

The NR unit 1523 is constituted similarly to the NR unit 1513. The NR unit 1523 performs noise elimination (noise reduction) on the B′ image. The NR unit 1523 outputs the B′ image on which the noise elimination has been performed to the display unit 160.

The first image processing unit 151 and the second image processing unit 152 perform the luminance adjustment processing such that a luminance value of the brightest area in the R′ image and a luminance value of the brightest area in the B′ image are matched with each other. The NR unit 1513 and the NR unit 1523 perform suitable processing on the basis of filter characteristics according to analog gain setting such that signal-to-noise (SN) values are matched between the R′ image and the B′ image.

In each aspect of the present invention, the noise elimination is not essential. For this reason, an imaging apparatus and an endoscope apparatus according to each aspect of the present invention may not include configurations corresponding to the NR parameter setting unit 1512, the NR unit 1513, the NR parameter setting unit 1522, and the NR unit 1523.

There are cases in which the contrast of an image deteriorates when the NR unit 1513 and the NR unit 1523 perform processing. In these cases, enhancement processing may be performed at the later stage of the NR unit 1513 and the NR unit 1523. An image processing system dealing with color images typically have an image processing function of color adjustment (color matrix or the like). In each embodiment of the present invention, since the display unit 160 displays an image in a monochromatic way, a typical function of color adjustment may not be mounted.

The image processing unit 150 may perform contrast adjustment processing on a processing target image determined by the determination unit 140 such that the difference of contrast between the R′ image and the B′ image becomes small. The determination unit 140 and the image processing unit 150 may be integrated.

The demosaic processing unit 120, the correction unit 130, the determination unit 140, and the image processing unit 150 may be constituted by an application specific integrated circuit (ASIC), a field-programmable gate array (FPGA), a microprocessor, and the like. For example, the demosaic processing unit 120, the correction unit 130, the determination unit 140, and the image processing unit 150 may be constituted by an ASIC and an embedded processor. The demosaic processing unit 120, the correction unit 130, the determination unit 140, and the image processing unit 150 may be constituted by hardware, software, firmware, or combinations thereof other than the above.

The display unit 160 is a transparent type liquid crystal display (LCD) requiring backlight, a self-light-emitting type electro luminescence (EL) element (organic EL), and the like. For example, the display unit 160 is constituted as a transparent type LCD and includes a driving unit necessary for LCD driving. The driving unit generates a driving signal and drives an LCD by using the driving signal. The display unit 160 may include a first display unit that displays the first monochrome correction image (R′ image) and a second display unit that displays the second monochrome correction image (B′ image).

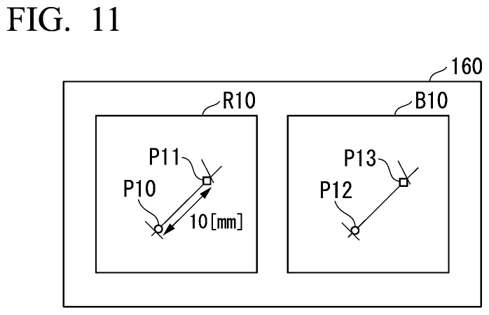

FIG. 11 shows an example of an image displayed on the display unit 160. An R′ image R10 and a B′ image B10 that are monochrome correction images are displayed. For example, a user designates a measurement point for the R′ image R10. A measurement point P10 and a measurement point P11 designated by a user are superimposed and displayed on the R′ image R10. In addition, the distance (10 [mm]) between two points on a subject corresponding to the measurement point P10 and the measurement point P11 is superimposed and displayed on the R′ image R10 as a measurement result. A point P12 corresponding to the measurement point P10 and a point P13 corresponding to the measurement point P11 are superimposed and displayed on the B′ image B10. Since the difference of image quality between the R′ image R10 and the B′ image B10 is small due to image processing performed by the image processing unit 150, visibility of an image is improved.

The imaging apparatus 10 may be an endoscope apparatus. In an industrial endoscope, the pupil division optical system 100 and the imaging device 110 are disposed at the distal end of an insertion unit that is to be inserted into the inside of an object for observation and measurement.

The imaging apparatus 10 according to the first embodiment includes the correction unit 130 and thus can suppress double images due to color shift of an image. In addition, since a monochrome correction image is displayed, visibility of an image can be improved. In addition, the imaging apparatus 10 includes the image processing unit 150 that enables the difference of image quality between the first monochrome correction image and the second monochrome correction image to become small, and thus can further improve visibility of an image. Even when a user observes an image in a method in which a phase difference is acquired on the basis of an R image and a B image, the user can observe an image in which double images due to color shift are suppressed and visibility is improved.

Since the display unit 160 displays a monochrome correction image, the amount of information output to the display unit 160 is reduced. For this reason, power consumption of the display unit 160 can be reduced.

### Modified Example of First Embodiment

In a modified example of the first embodiment, the determination unit 140 performs a first operation and a second operation in a time-division manner. The determination unit 140 determines a first monochrome correction image as a processing target image and outputs the determined processing target image to the image processing unit 150 in the first operation. The determination unit 140 determines a second monochrome correction image as a processing target image and outputs the determined processing target image to the image processing unit 150 in the second operation.

The image processing unit 150 includes any one of the first image processing unit 151 and the second image processing unit 152. For example, the image processing unit 150 includes the first image processing unit 151. The determination unit 140 outputs an R′ image to the image processing unit 150 in the first operation. At this time, the determination unit 140 stops outputting of a B′ image to the image processing unit 150. The first image processing unit 151 performs luminance adjustment processing on the R′ image. The determination unit 140 outputs the B′ image to the image processing unit 150 in the second operation. At this time, the determination unit 140 stops outputting of the R′ image to the image processing unit 150. The first image processing unit 151 performs the luminance adjustment processing on the B′ image. The determination unit 140 alternately performs the first operation and the second operation.

For example, the R′ image and the B′ image are moving images. The image processing unit 150 alternately outputs the R′ image and the B′ image processed by the first image processing unit 151 to the display unit 160. The display unit 160 displays the R′ image and the B′ image and updates the R′ image and the B′ image at a predetermined frame cycle. The display unit 160 alternately performs update of the R′ image and update of the B′ image. When the R′ image is output from the image processing unit 150, the display unit 160 updates the R′ image out of the R′ image and the B′ image that are displayed. When the B′ image is output from the image processing unit 150, the display unit 160 updates the B′ image out of the R′ image and the B′ image that are displayed.

The image processing unit 150 according to the modified example of the first embodiment includes any one of the first image processing unit 151 and the second image processing unit 152. For this reason, it is possible to reduce circuit scale or operation costs and also reduce power consumption.

### Second Embodiment

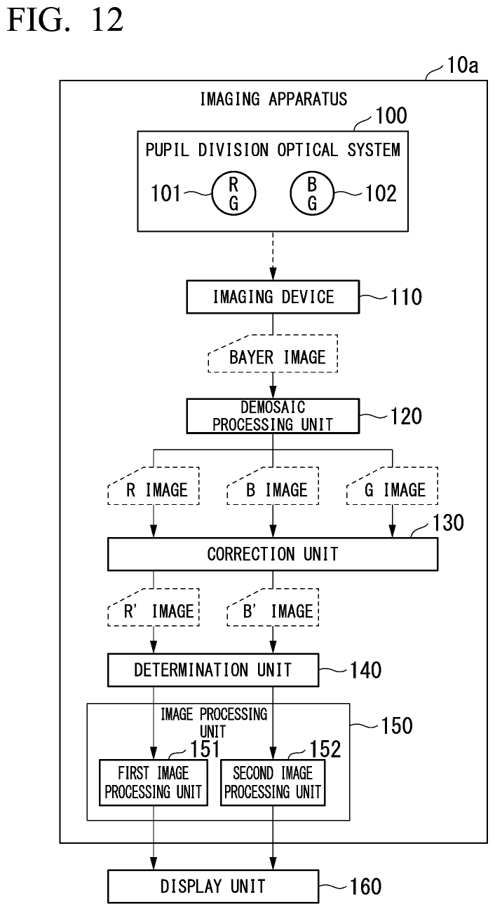

FIG. 12 shows a configuration of an imaging apparatus 10a according to a second embodiment of the present invention. In terms of the configuration shown in FIG. 12, differences from the configuration shown in FIG. 1 will be described.

The imaging apparatus 10a does not include the display unit 160. The display unit 160 is constituted independently of the imaging apparatus 10a. A first monochrome correction image and a second monochrome correction image output from the image processing unit 150 may be output to the display unit 160 via a communicator. For example, the communicator performs wired or wireless communication with the display unit 160.

In terms of points other than the above, the configuration shown in FIG. 12 is similar to the configuration shown in FIG. 1.

The imaging apparatus 10a according to the second embodiment can suppress double images due to color shift and improve visibility as with the imaging apparatus 10 according to the first embodiment. Since the display unit 160 is independent of the imaging apparatus 10a, the imaging apparatus 10a can be miniaturized. In addition, by transferring a monochrome correction image, the frame rate when an image is transferred to the display unit 160 increases and the bit rate is reduced compared to a color image.

### Third Embodiment

A third embodiment of the present invention will be described using the imaging apparatus 10 shown in FIG. 1. In the third embodiment, the determination unit 140 determines at least one of a first monochrome correction image and a second monochrome correction image as a processing target image on the basis of a result of comparing the first monochrome correction image with the second monochrome correction image.

For example, an R′ image has been determined as a reference image out of the R′ image and a B′ image in advance. The determination unit 140 calculates a proportion of a luminance value of the B′ image to a luminance value of the R′ image. For example, the determination unit 140 compares the average luminance value in a detection area of the R′ image with the average luminance value in a detection area of the B′ image. For example, the detection area is the center area (100×100 pixels) of the pixel area (500×500 pixels) of a CMOS sensor. The determination unit 140 calculates a proportion of the average luminance value of the B′ image to the average luminance value of the R′ image. The determination unit 140 determines a gain value of luminance adjustment processing performed by the image processing unit 150 on the basis of the calculated proportion.

For example, in a case where the average luminance value of the R′ image is 800 and the average luminance value of the B′ image is 400, a proportion of a luminance value of the B′ image to a luminance value of the R′ image is 0.5. For this reason, a gain value that is twice a gain value set in the luminance adjustment unit 1511 that processes the R′ image is set in the luminance adjustment unit 1521 that processes the B′ image.

There is parallax between the R′ image and the B′ image. For this reason, a luminance value may be determined in an area that is wide to some extent and is hardly affected by an influence of the parallax instead of a small area such as one pixel at the center of an image.

The determination unit 140 may determine a processing target image on the basis of a result of analyzing a histogram of pixel values of each of the R′ image and the B′ image. A method of comparing the R′ image with the B′ image is not limited to the above-described method. The display unit 160 may be constituted independently of the imaging apparatus 10.

The imaging apparatus 10 according to the third embodiment can suppress double images due to color shift and improve visibility as with the imaging apparatus 10 according to the first embodiment.

### Fourth Embodiment

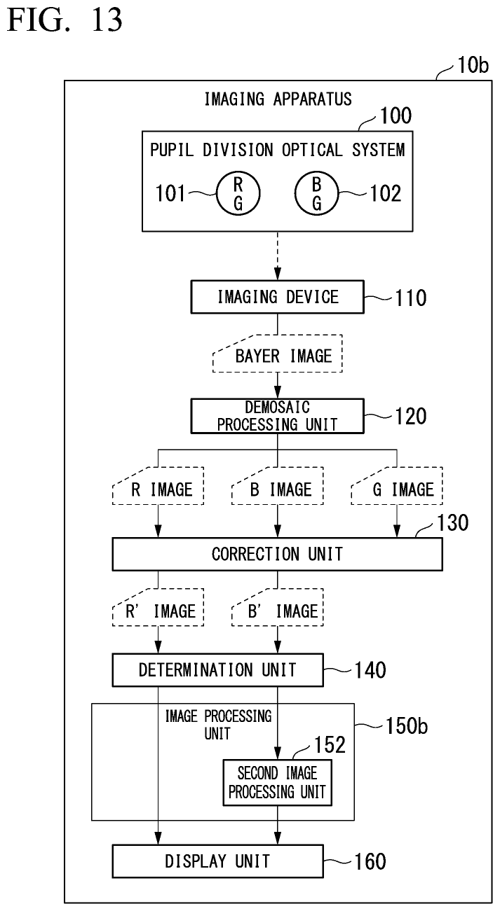

FIG. 13 shows a configuration of an imaging apparatus 10b according to a fourth embodiment of the present invention. In terms of the configuration shown in FIG. 13, differences from the configuration shown in FIG. 1 will be described.

In the imaging apparatus 10b, the image processing unit 150 shown in FIG. 1 is changed to an image processing unit 150b. The image processing unit 150b includes a second image processing unit 152. The image processing unit 150b does not include a first image processing unit 151.

The determination unit 140 determines an image that has poorer image quality out of a first monochrome correction image and a second monochrome correction image as a processing target image. The determination unit 140 outputs the image determined as the processing target image out of the first monochrome correction image and the second monochrome correction image to the image processing unit 150b. In addition, the determination unit 140 outputs the image different from the image determined as the processing target image out of the first monochrome correction image and the second monochrome correction image to the display unit 160. In other words, the determination unit 140 outputs an image that has superior image quality out of the first monochrome correction image and the second monochrome correction image to the display unit 160.

For example, the determination unit 140 determines an image that has a lower luminance value out of the first monochrome correction image and the second monochrome correction image as the processing target image. For example, when a luminance value of a B′ image is lower than that of an R′ image, the determination unit 140 determines the B′ image as the processing target image. For example, comparison of luminance values between the R′ image and the B′ image is made by comparing average luminance values as with the third embodiment. The determination unit 140 outputs the B′ image to the second image processing unit 152 and outputs the R′ image to the display unit 160. In addition, the determination unit 140 determines a gain value for the B′ image and the determined gain value to the second image processing unit 152. For example, the determination unit 140 determines a gain value such that a luminance level of the R′ image and a luminance level of the B′ image become the same. Specifically, the determination unit 140 determines a gain value such that the maximum luminance value of the R′ image and the maximum luminance value of the B′ image become the same.

The second image processing unit 152 performs image processing on the B′ image selected as the processing target image such that image quality of the B′ image approaches image quality of the R′ image. In other words, the second image processing unit 152 performs luminance adjustment processing on the B′ image such that a luminance value of the B′ image approaches a luminance value of the R′ image. Specifically, the second image processing unit 152 performs the luminance adjustment processing such that the maximum luminance value of the R′ image and the maximum luminance value of the B′ image become the same. The luminance adjustment processing is not performed on the R′ image. The display unit 160 displays the B′ image output from the second image processing unit 152 and the R′ image output from the determination unit 140.

In terms of points other than the above, the configuration shown in FIG. 13 is similar to the configuration shown in FIG. 1.

The determination unit 140 may determine an image that has a higher luminance value out of the first monochrome correction image and the second monochrome correction image as the processing target image. An image processing unit included in the image processing unit 150b may be either the first image processing unit 151 or the second image processing unit 152. Noise elimination may be performed on an image output from the determination unit 140 to the display unit 160. The display unit 160 may be constituted independently of the imaging apparatus 10b.

The imaging apparatus 10b according to the fourth embodiment can suppress double images due to color shift and improve visibility as with the imaging apparatus 10 according to the first embodiment.

In addition, the image processing unit 150b according to the fourth embodiment has any one of the first image processing unit 151 and the second image processing unit 152. For this reason, it is possible to reduce circuit scale or operation costs and also reduce power consumption.

### Fifth Embodiment

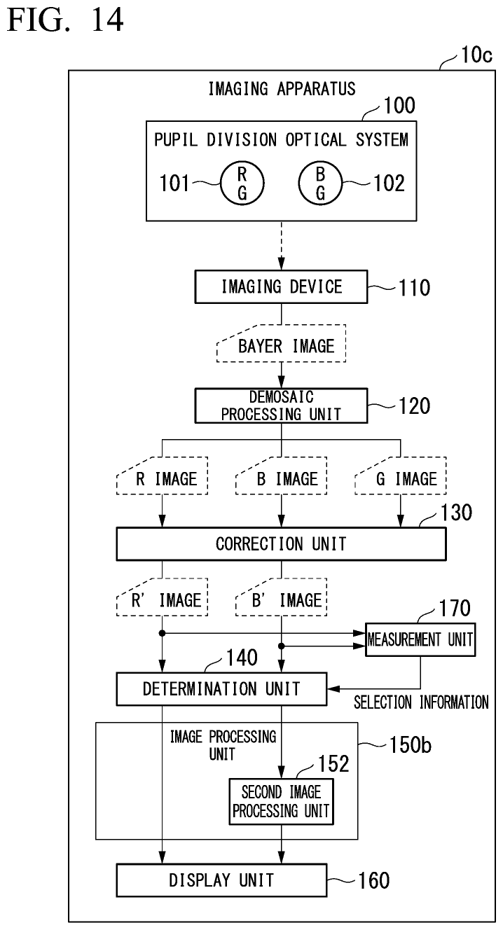

FIG. 14 shows a configuration of an imaging apparatus 10c according to a fifth embodiment of the present invention. In terms of the configuration shown in FIG. 14, differences from the configuration shown in FIG. 13 will be described.

The imaging apparatus 10c includes a measurement unit 170 in addition to the configuration of the imaging apparatus 10b shown in FIG. 13. The measurement unit 170 calculates a phase difference of a reference image for a standard image. The standard image is any one of a first monochrome correction image and a second monochrome correction image. The reference image is the image different from the standard image out of the first monochrome correction image and the second monochrome correction image. The determination unit 140 outputs an image that is the reference image out of the first monochrome correction image and the second monochrome correction image to the image processing unit 150. In addition, the determination unit 140 outputs an image that is the standard image out of the first monochrome correction image and the second monochrome correction image to the display unit 160. For this reason, the determination unit 140 determines the image that is the reference image out of the first monochrome correction image and the second monochrome correction image as the processing target image. In addition, the determination unit 140 outputs the image different from the image determined as the processing target image out of the first monochrome correction image and the second monochrome correction image to the display unit 160.

The correction unit 130 outputs an R′ image and a B′ image to the determination unit 140 and the measurement unit 170. The measurement unit 170 selects any one of the R′ image and the B′ image as the standard image. In addition, the measurement unit 170 selects the image different from the image selected as the standard image out of the R′ image and the B′ image as the reference image.

For example, the measurement unit 170 selects the standard image and the reference image on the basis of luminance values of the R′ image and the B′ image. Specifically, the measurement unit 170 determines an image that has a higher luminance value out of the R′ image and the B′ image as the standard image. In addition, the measurement unit 170 determines an image that has a lower luminance value out of the R′ image and the B′ image as the reference image. The measurement unit 170 may select the standard image and the reference image on the basis of contrast of the R′ image and the B′ image. For example, the measurement unit 170 determines an image that has higher contrast out of the R′ image and the B′ image as the standard image. In addition, the measurement unit 170 determines an image that has lower contrast out of the R′ image and the B′ image as the reference image. The measurement unit 170 may select the standard image and the reference image on the basis of an instruction from a user. In the example shown in FIG. 14, the measurement unit 170 selects the R′ image as the standard image and the B′ image as the reference image.

A method of selecting the standard image and the reference image is not limited to the above-described method. As long as the standard image and the reference image are suitable for calculation of a phase difference, a method of selecting the standard image and the reference image is not particularly limited.

For example, a measurement point that is a position at which a phase difference is calculated is set by a user. The measurement unit 170 calculates a phase difference at the measurement point. The measurement unit 170 calculates a distance of a subject on the basis of the phase difference. For example, when one arbitrary point on an image is designated by a user, the measurement unit 170 performs measurement of depth. When two arbitrary points on an image are designated by a user, the measurement unit 170 can measure the distance between the two points. For example, character information of a measurement value that is a measurement result is superimposed on the R′ image or the B′ image such that a user can visually confirm the measurement result. The measurement unit 170 is constituted by an ASIC, an FPGA, a microprocessor, and the like.

Information of the standard image and the reference image selected by the measurement unit 170 is output to the determination unit 140 as selection information. The determination unit 140 outputs an image corresponding to the reference image represented by the selection information out of the R′ image and the B′ image to the second image processing unit 152. In addition, the determination unit 140 outputs an image corresponding to the standard image represented by the selection information out of the R′ image and the B′ image to the display unit 160.

The selection information may represent only any one of the standard image and the reference image. When the selection information represents which image is the standard image out of the R′ image and the B′ image, the determination unit 140 outputs an image different from an image represented by the selection information out of the R′ image and the B′ image to the second image processing unit 152. In addition, the determination unit 140 outputs the image represented by the selection information out of the R′ image and the B′ image to the display unit 160. When the selection information represents which image is the reference image out of the R′ image and the B′ image, the determination unit 140 outputs an image represented by the selection information out of the R′ image and the B′ image to the second image processing unit 152. In addition, the determination unit 140 outputs an image different from the image represented by the selection information out of the R′ image and the B′ image to the display unit 160.

The determination unit 140 may determine the standard image and the reference image. In this case, the selection information is output from the determination unit 140 to the measurement unit 170. The measurement unit 170 selects the standard image and the reference image on the basis of the selection information.

In terms of points other than the above, the configuration shown in FIG. 14 is similar to the configuration shown in FIG. 13.

An image processing unit included in the image processing unit 150b may be either the first image processing unit 151 or the second image processing unit 152. Noise elimination may be performed on an image output from the determination unit 140 to the display unit 160. The display unit 160 may be constituted independently of the imaging apparatus 10c.

The imaging apparatus 10c according to the fourth embodiment can suppress double images due to color shift and improve visibility as with the imaging apparatus 10 according to the first embodiment.

In addition, the image processing unit 150b according to the fifth embodiment has any one of the first image processing unit 151 and the second image processing unit 152. For this reason, it is possible to reduce circuit scale or operation costs and also reduce power consumption.

Since the difference of image quality between the standard image and the reference image when measurement is performed is suppressed, a user can easily designate a measurement point on an image of which visibility has been improved. For this reason, work efficiency of a user is improved. A user typically performs pointing at a measurement point on the standard image. When image quality of the reference image approaches image quality of the standard image, visibility is improved.

While preferred embodiments of the invention have been described and shown above, it should be understood that these are examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An imaging apparatus comprising:
a pupil division optical system including a first pupil transmitting light of a first wavelength band and a second pupil transmitting light of a second wavelength band different from the first wavelength band;
an imaging device configured to capture an image of light transmitted through the pupil division optical system and a first color filter having a first transmittance characteristic and light transmitted through the pupil division optical system and a second color filter having a second transmittance characteristic partially overlapping the first transmittance characteristic, and output the captured image;
a processor configured to:
generate a first monochrome correction image and a second monochrome correction image, the first monochrome correction image being an image generated by correcting a value that is based on components overlapping between the first transmittance characteristic and the second transmittance characteristic for the captured image having components that are based on the first transmittance characteristic, the second monochrome correction image being an image generated by correcting a value that is based on components overlapping between the first transmittance characteristic and the second transmittance characteristic for the captured image having components that are based on the second transmittance characteristic;
determine at least one of the first monochrome correction image and the second monochrome correction image as a processing target image; and
perform image processing on the processing target image such that the difference of image quality between the first monochrome correction image and the second monochrome correction image becomes small,
wherein the first monochrome correction image and the second monochrome correction image are output to a display unit, and
at least one of the first monochrome correction image and the second monochrome correction image output to the display unit is an image on which the image processing has been performed by the processer.

2. The imaging apparatus according to claim 1,
wherein the processer is configured to determine at least one of the first monochrome correction image and the second monochrome correction image as the processing target image on the basis of a result of comparing the first monochrome correction image with the second monochrome correction image.

3. The imaging apparatus according to claim 1,
wherein the processer is configured to perform luminance adjustment processing on the processing target image such that the difference of luminance between the first monochrome correction image and the second monochrome correction image becomes small.

4. The imaging apparatus according to claim 2,
wherein the processer is configured to:
determine an image that has poorer image quality out of the first monochrome correction image and the second monochrome correction image as the processing target image;
perform the image processing on the processing target image out of the first monochrome correction image and the second monochrome correction image; and
output the image different from the processing target image out of the first monochrome correction image and the second monochrome correction image to the display unit.

5. The imaging apparatus according to claim 2,
wherein the processer is configured to calculate a phase difference of a reference image for a standard image,
the standard image is one of the first monochrome correction image and the second monochrome correction image,
the reference image is the other of the first monochrome correction image and the second monochrome correction image, and
the processer is configured to perform the image processing on the reference image and output the standard image to the display unit.

6. The imaging apparatus according to claim 1,
wherein the processer is configured to perform a first operation and a second operation in a time-division manner,
the processer is configured to determine the first monochrome correction image as the processing target image and perform the image processing on the determined processing target image in the first operation, and
the processer is configured to determine the second monochrome correction image as the processing target image and perform the image processing on the determined processing target image in the second operation.

7. An imaging apparatus comprising:
a pupil division optical system including a first pupil transmitting light of a first wavelength band and a second pupil transmitting light of a second wavelength band different from the first wavelength band;
an imaging device configured to capture an image of light transmitted through the pupil division optical system and a first color filter having a first transmittance characteristic and light transmitted through the pupil division optical system and a second color filter having a second transmittance characteristic partially overlapping the first transmittance characteristic, and output the captured image;
a correction unit configured to output a first monochrome correction image and a second monochrome correction image, the first monochrome correction image being an image generated by correcting a value that is based on components overlapping between the first transmittance characteristic and the second transmittance characteristic for the captured image having components that are based on the first transmittance characteristic, the second monochrome correction image being an image generated by correcting a value that is based on components overlapping between the first transmittance characteristic and the second transmittance characteristic for the captured image having components that are based on the second transmittance characteristic;
a determination unit configured to determine at least one of the first monochrome correction image and the second monochrome correction image as a processing target image; and
an image processing unit configured to perform image processing on the processing target image determined by the determination unit such that the difference of image quality between the first monochrome correction image and the second monochrome correction image becomes small,
wherein the first monochrome correction image and the second monochrome correction image are output to a display unit, and
at least one of the first monochrome correction image and the second monochrome correction image output to the display unit is an image on which the image processing has been performed by the image processing unit.

8. An endoscope apparatus comprising the imaging apparatus according to claim 1.
